(19) United States
(12) Patent Application Publication
(10) Pub. No.: US 2013/0271744 A1
(43) Pub. Date: Oct. 17, 2013

(54) LASER RANGEFINDER MODULE FOR OPERATIVE ASSOCIATION WITH SMARTPHONES AND TABLET COMPUTERS

(71) Applicants: Eric André Miller, Englewood, CO (US); Ji Yoon Chung, Aurora, CO (US)

(72) Inventors: Eric André Miller, Englewood, CO (US); Ji Yoon Chung, Aurora, CO (US)

(73) Assignees: Kama-Tech (HK) Limited, Tsim Sha Tsui (CN); Laser Technology, Inc., Centennial, CO (US)

(21) Appl. No.: 13/446,997

(22) Filed: Apr. 13, 2012

(51) Int. Cl. G01C 3/08

(52) U.S. Cl. 356/4.01

(57) ABSTRACT

A laser rangefinding module for cable connected and/or wireless operative association with smartphones and tablet computers. In a particular embodiment of the present invention disclosed herein, the operation of the laser rangefinder module is controlled by the smartphone or tablet computer and functions through the smartphone touchscreen with the laser rangefinder results being displayed on the smartphone display.

### BACKGROUND OF THE INVENTION

The present invention relates, in general, to the field of laser-based rangefinding and speed measurement instruments. More particularly, the present invention relates to a laser rangefinding module for cable connected and/or wireless operative association with smartphones and tablet computers.

Smartphones, tablet computers and the like are becoming relatively ubiquitous and are communication devices with many capabilities built into a single handheld device over and above the sending and receiving of cellular telephone transmissions. Among the additional features often provided are the sending and receiving of text messages; a keyboard, touchscreen or other display; email capability; a personal organizer; a still and/or video camera; navigation hardware and software; software for viewing video clips or playing music and/or games; viewing photos; an Internet browser and contact list and other data storage as the onboard memory allows.

In addition, a great number of software applications (“apps”) are available for such devices which further augment their capabilities. Given their ever increasing processing power, ancillary subsystems such as global positioning system (GPS), gyroscopes, magnetic sensors and the like in addition to cameras, touchscreen displays, Bluetooth and other wireless communications capabilities, it would be highly desirable to more fully utilize these features in conjunction with other devices.

### SUMMARY OF THE INVENTION

Disclosed herein is a laser rangefinder module which functions as either a cable connected and/or wireless accessory module attachment for a smartphone or tablet computer. In a particular embodiment disclosed herein a universal mechanical cradle design can be implemented to allow for the physical and removable attachment of various models of smartphones from various manufacturers. Provided herein are multiple options for communication between the smartphone and the laser rangefinder module such as Bluetooth, WiFi, or other near field communication (NFC) medium in addition to wired connection such as RS232, universal serial bus (USB) and the like.

In a particular embodiment of the present invention, the operation of the laser rangefinder module is controlled by the smartphone and functions through the smartphone touchscreen with the laser rangefinder results being displayed on the smartphone display. The laser rangefinder module includes the laser transmission and reception optics together with the necessary electrical and mechanical hardware. The laser rangefinder module can be conveniently configured to function in conjunction with an application program operating in conjunction with the primary smartphone operating systems (OS) including those available from Apple, Inc. and Android (a trademark of Google, Inc.).

Functionally, a laser rangefinder module in accordance with the present invention may be provided in various models with varying capabilities including 905 nm, pulse, 500 yard plus maximum range, +/−1 yard accuracy; 650 nm, phase modulated, 100 yard plus range +/−3 mm accuracy and the like depending on the application for which it is intended. As disclosed herein, the laser rangefinder module may utilize the smartphone camera for aiming and incorporate a mirror, prism or other light redirecting system in the laser rangefinder module to project the camera towards the laser rangefinder range and/or speed measurement target.

A laser rangefinder module in accordance with the present invention may also use the smartphone camera aiming alignment function wherein the target is viewed on the smartphone touchscreen display allowing the operator to touch the target image to center the screen view on the target and overlay an aiming reticule. Also as disclosed herein, the laser rangefinder module can further provide an optional visible laser pointer/aiming system to assist in target aiming and identification.

The laser rangefinder module operations may be controlled by the smartphone to include selecting and changing between measurement units (e.g. feet/meters); selecting targeting modes (closest target, farthest target, scan mode, distance hold-off and the like). In addition, the smartphone/laser rangefinder module system disclosed herein can also utilize the smartphone's onboard tilt sensor to be combined with range data to calculate tilt corrected distances such as horizontal distances, vertical distances etc. Moreover, the laser rangefinder module can utilize the determined distance to a target combined with the smartphone tilt measurements to implement remote target height calculation routines including slope distance, bottom angle, top angle and the like.

In still further embodiments of the present invention, a smartphone/laser rangefinder module system may utilize the smartphone onboard GPS function to store position information of the laser rangefinder targets as well as utilize the smartphone onboard magnetic sensor to combine with range data to determine the three dimensional position of remote targets. Over and above the foregoing features, application specific user interface configuration options can be developed (e.g. those for carpet layers, real estate agents, painters, hunters, golfers etc.) and such application specific user options can be made readily available to be downloaded from a website (e.g. Apple® Store, company website etc.)

Particularly disclosed herein is a laser rangefinder which comprises a laser rangefinder module and a smartphone in operative association with the laser rangefinder. The smartphone comprises a user interface and an application program for operatively controlling the laser rangefinder module. The laser rangefinder module is at least partially operative in response to the smartphone user interface.

Further disclosed herein is a laser rangefinder module which comprises a laser transmit section for directing laser energy toward a target, a laser receive section for receiving at least a portion of the laser energy reflected from the target, a central processing section for determining a distance to the target and a smartphone including a user viewable display, the smartphone in operative association with the central processing section to present information corresponding to the distance to the target on the display.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIGS. 1A and 1B are block diagrams illustrative of the functional aspects of a laser rangefinder module and a typical smartphone and indicative of how the two devices can interact through both wired and/or wireless coupling;

FIG. 2 is an exploded isometric view of one embodiment of a laser rangefinder module for the physical mounting and removable retention of a typical smartphone within a recess thereof and further illustrating an optical pathway design for enabling the smartphone camera to be utilized in conjunction with the laser rangefinder module;

FIG. 3 is a further isometric view of the combination of the laser rangefinder module and smartphone of the preceding figure illustrative of the laser module transmission and reception pathways and the visual pathway to a target enabled through the smartphone camera;

FIG. 4 is another isometric view of the laser rangefinder module and smartphone combination of the preceding figure illustrative of how the combined unit can utilize the smartphone touchscreen display to present a view of a target and ancillary range and laser rangefinder operational mode information as well;

FIG. 5 is a side plan, cut-away view of the laser rangefinder module and smartphone combination of the preceding figures illustrative of the smartphone camera lens and laser rangefinder optical pathway for enabling, inter alia, a view of a target on the smartphone touchscreen display;

FIG. 6 is an exploded, end plan view of the laser rangefinder module and smartphone combination of the preceding figures;

FIG. 7 is an alternative embodiment of a laser rangefinder module and smartphone combination wherein the smartphone is coupled to the laser rangefinder module by an electrical connector instead of, or in addition to, a wireless interconnection of the two devices; and

FIG. 8 is an illustration of yet another alternative embodiment of a laser rangefinder module in accordance with the present invention wherein the laser rangefinder module is not physically combined with a smartphone or tablet computer and is wirelessly coupled to either or both of these two devices and is independently aimed at a target.

### DESCRIPTION OF A REPRESENTATIVE EMBODIMENT

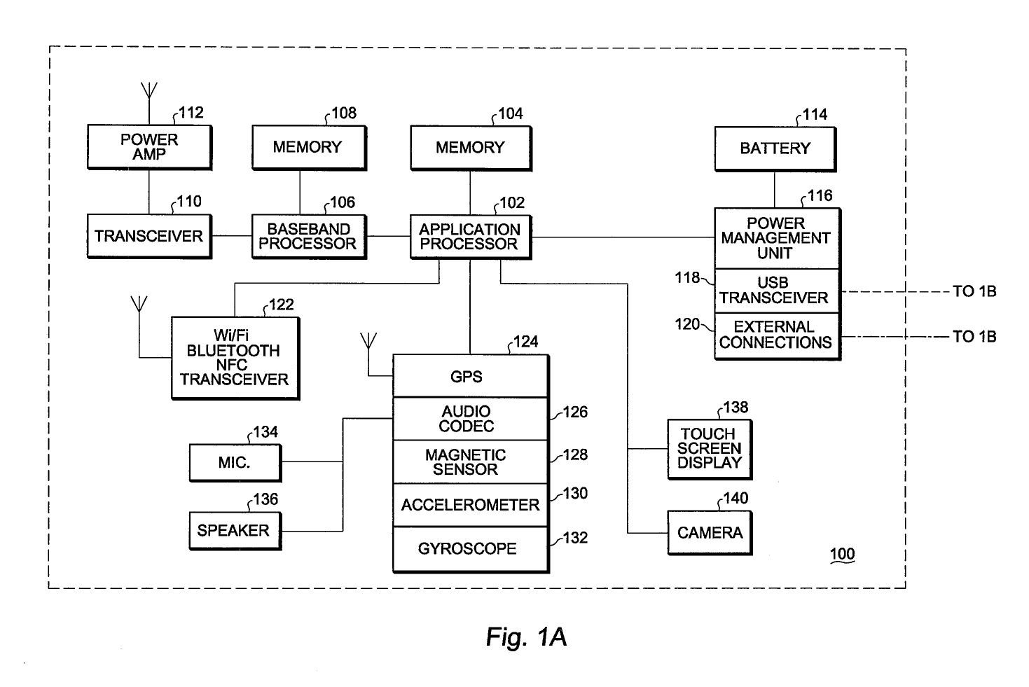

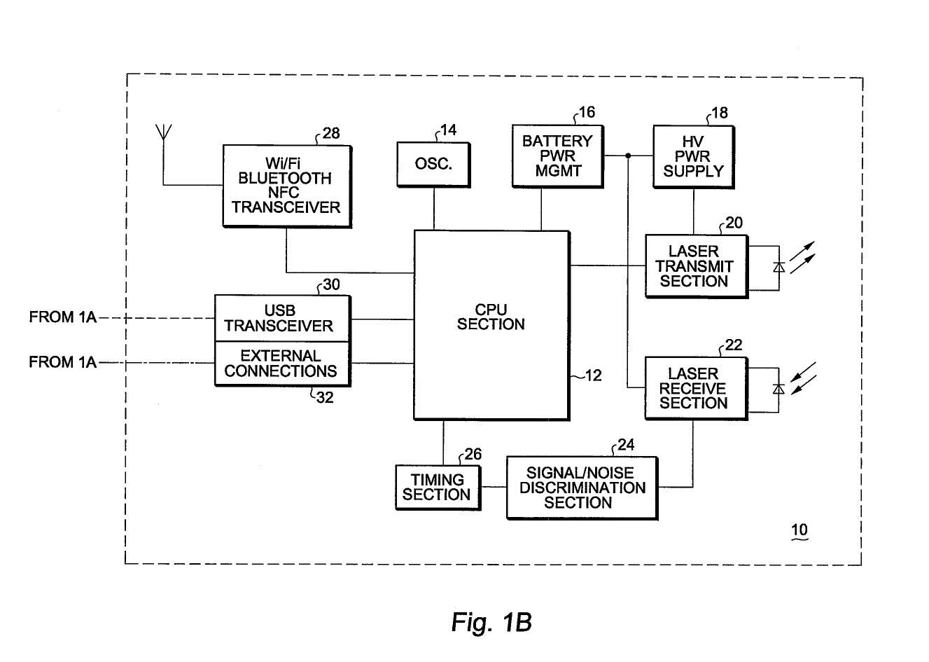

With reference now to FIGS. 1A and 1B, block diagrams illustrative of the functional aspects of a laser rangefinder module 10 and a typical smartphone 100 are shown and indicative how the two devices 10, 100 can interact through both wired and/or wireless coupling to each other. As used herein the term “smartphone” is also intended to comprise tablet computers and other similarly featured devices.

A laser rangefinder module 10 in accordance with a particular embodiment of the present invention may comprise a central processing unit (CPU) section 12 with an associated oscillator 14 for providing clocking signals to the CPU section 12 and module 10. A battery and power management section 16 supplies operating power to the CPU section 12 and the various module subsystems as well as the high voltage (HV) power supply 18 which provides operating voltage to a laser transmit section 20 and associated laser diode as well as a laser receive section 22.

The laser receive section 22 receives a portion of the laser energy transmitted by the laser transmit section 20 as reflected by a target through a laser detection diode and provides the return signals to a signal/noise discriminator section 24 in order to separate true return pulses from any associated noise. A timing section 26 accurately measures the time between the transmission of laser pulses from the laser transmit section 20 and the reception of the same target reflected pulses at the laser receive section 22 to determine, in conjunction with the CPU section 12, the distance to the particular target towards which the module 10 is aimed.

In the particular embodiment of the laser rangefinder module 10 illustrated, the CPU section 12 may have an associated section 28 comprising a IEEE 802.11 (WiFi), or other wireless local area network (WLAN) transceiver; a Bluetooth transceiver or other personal are network (PAN) system for wirelessly exchanging data over short distances; and/or another near field communication (NFC) transceiver (inclusive of infrared (IR) coupling) for wirelessly coupling the laser rangefinder module 10 to, for example, a smartphone 100 or similarly configured tablet computer.

In addition to, or in substitution for, the wireless transceiver 28, the laser rangefinder module 10 may comprise, for example, a universal serial bus (USB) transceiver 30 or other external connections 32 for wired coupling between the laser rangefinder module 10 and a smartphone 100.

The subsystems of a representative smartphone 100 or similarly configured tablet computer are also illustrated and it comprises, in pertinent part, an application processor 102 and associated memory 104 which may comprise both non-volatile memory devices as well as volatile synchronous dynamic random access memory (SDRAM) devices. The applications processor 102 is coupled to a baseband processor 106 which also has associated memory 108 which may additionally include non-volatile memory devices. The baseband processor 106 is operatively coupled to a transceiver 110 and associated power amplifier 112 to enable two way telephonic and/or text message communication in a cellular telephone system.

The application processor 102 and the smartphone 100 incorporates a battery 114 and associated power management unit 116 and may also incorporate a USB transceiver 118 as well as external connections 120 to, for example, a battery charging unit (not shown) as well as other industry standard or proprietary signal connectors such as an Apple 30 pin connector. The USB transceiver 118 and external connections 120 may be used to provide data exchange with the corresponding USB transceiver 30 and external connections 32 of the laser rangefinder module 10 instead of, or in addition to any wireless communications between the devices 10, 100. As also illustrated, the smartphone 100 may further include a WiFi, Bluetooth and/or NFC transceiver 122 similar to the analogous transceiver 28 in the laser rangefinder module 10 to enable the wireless transfer of data between the two devices 10, 100.

A representative smartphone 100 or similarly configured tablet computer may also incorporate a global positioning system (GPS) subsystem 124, an audio encoder/decoder (CODEC) 126, a magnetic sensor 128, an accelerometer 130 and/or a gyroscope 132. The audio CODEC 126 is coupled to a microphone 134 and a speaker 136. A touchscreen display 138 for receiving user input and displaying information to the user and a camera subsystem 140 for recording still and motion images is coupled to the application processor 102. In operation in conjunction with the laser rangefinder module 10 of the present invention, the smartphone 100 or similarly configured tablet computer may be any of the available units currently sourced by Apple, Motorola, Samsung, LG, Nokia and others.

It should be noted that the laser rangefinder module 10 itself may also include one or more additional subsystems (not shown) such as a GPS subsystem, compass or magnetic sensor, accelerometer, gyroscope and the like where their inclusion might provide more accurate information than the corresponding subsystems or portions of the smartphone 100. In cabled associations between the laser rangefinder module 10 and the smartphone 100 it is also possible for the two devices to share battery power and associated power management functions.

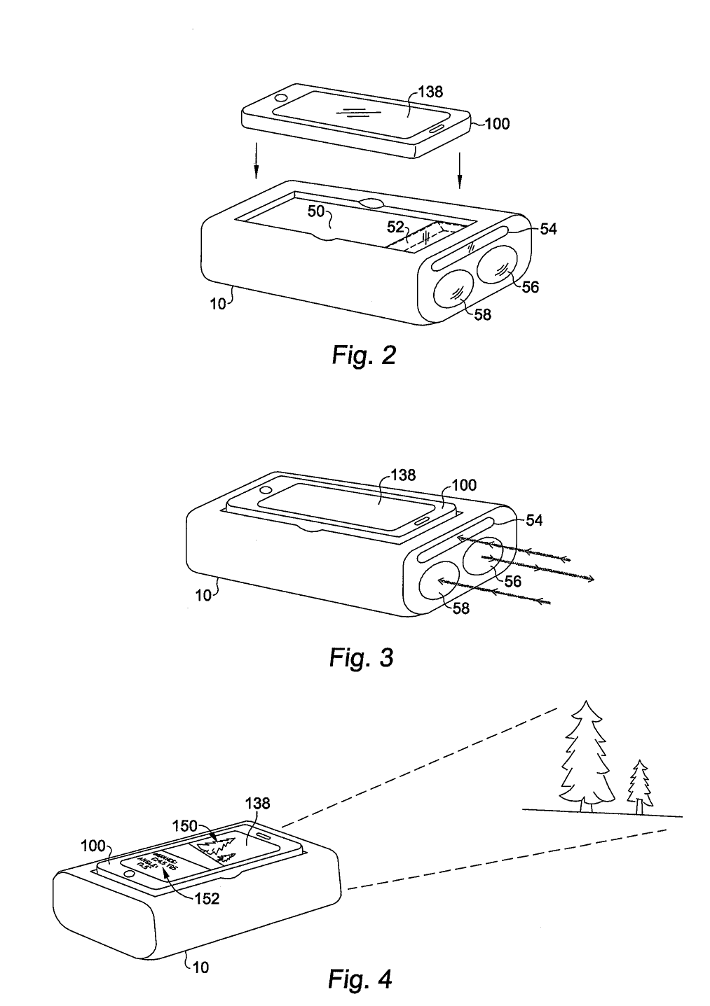

With reference additionally now to FIG. 2, an exploded isometric view of one embodiment of a laser rangefinder module 10 is shown for the physical mounting and removable retention of a typical smartphone 100 within a recess 50 of the laser rangefinder module 10. Illustrated is a portion of a possible optical pathway to enable a camera (e.g. camera 140 of FIG. 1A) on the underside of the smartphone 100 to provide a view of a target by means of a mirror 52 and a viewing aperture and/or optics 54. It should be noted that the mirror 52 may also be conveniently supplied as a prism or other appropriate light redirecting element. The viewing aperture and/or optics 54 can provide a magnified view of a target by means of an appropriate lens system if desired. In addition to removable retention of the smartphone 100 within a recess 50 of the laser rangefinder module 10, it should be noted that the former device can be otherwise clamped or affixed to the latter device through various other mechanisms.

It should also be noted that any inversion of the image of a target towards which the combination of the laser rangefinder module 10 and smartphone 100 is aimed due to the mirror 52 can be readily corrected through the software of an associated laser rangefinder application downloaded to the smartphone 100. In this manner, an image of the target can appear on the touchscreen display 138 along with an aiming reticule and other information concerning the distance to the target and the like. It should be noted that it is within the contemplation of the present invention that the speed of a moving target can also be determined by the laser rangefinder module 10 and an associated smartphone 100 though the determination of differing distance measurements as such measurements change over a given time period.

Also illustrated are the laser transmission aperture and optics 56 and the associated laser reception aperture and optics 58. In the particular embodiment of the laser rangefinder module 10 illustrated, the laser rangefinder module 10 and associated smartphone 100 may be operatively and communicatively linked via their respective wireless transceivers 28 and 122 (FIGS. 1A and 1B).

With reference additionally now to FIG. 3, a further isometric view of the combination of the laser rangefinder module 10 and smartphone 100 of the preceding figure is shown illustrative of the laser module transmission aperture and optics 56 (which may include, for example, an aspheric collimating lens systems) and laser reception aperture and optics 58 in addition to a view of the target to the smartphone 100 camera provided through the viewing aperture and/or optics 54.

With reference additionally now to FIG. 4, another isometric view of the laser rangefinder module 10 and smartphone 100 combination of the preceding figure is shown illustrative of how the combined unit can utilize the smartphone 100 touchscreen display 138 to present a view 150 of a target (for example, the trees illustrated) and ancillary range and laser rangefinder operational mode information 152 as well. In this regard, data representative of the type of information 152 that can be illustrated on the touchscreen display is disclosed, for example, in U.S. Pat. No. 6,057,910. In addition, the operational aspects and functionality of the laser rangefinder module 10 in conjunction with the smartphone 100 can also be as disclosed, for example, in U.S. Pat. Nos. 5,528,518; 5,696,705; 5,806,020; 6,738,148 and 7,920,251. The foregoing patents are all assigned to Laser Technology, Inc., assignee of the present invention, the disclosure of which are herein specifically incorporated by this reference in their entirety.

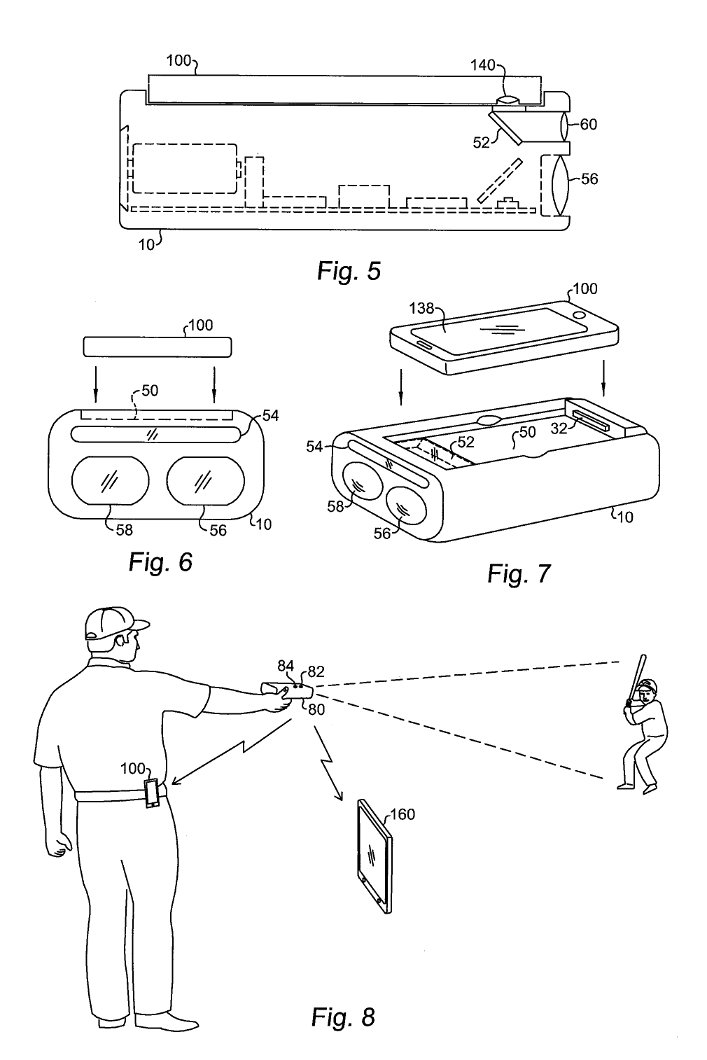

With reference additionally now to FIG. 5, a cut-away, side plan view of the laser rangefinder module 10 and smartphone 100 combination of the preceding figures is shown illustrative of the smartphone camera 140 lens and laser rangefinder optical pathway 54 (FIG. 3) which includes mirror 52 and lens 60 for enabling, inter alia, a view of a target on the smartphone 100 touchscreen display 138 (FIG. 3).

With reference additionally now to FIG. 6, an exploded, end plan view of the laser rangefinder module 10 and smartphone 100 combination of the preceding figures is shown.

With reference additionally now to FIG. 7, an alternative embodiment of a laser rangefinder module 10 and smartphone 100 combination is shown wherein the smartphone 100 is coupled to the laser rangefinder module 10 by an electrical connector comprising external connections 32 instead of, or in addition to, a wireless interconnection of the two devices 10, 100. With respect to FIGS. 5 through 7 inclusive, like structure to that previously illustrated and described is like numbered and the foregoing description thereof shall suffice herefor.

With reference additionally now to FIG. 8, an illustration of yet another alternative embodiment of a laser rangefinder module 80 in accordance with the present invention is shown wherein the laser rangefinder module 80 is not physically combined with a smartphone 100 or tablet computer 160 and is wirelessly coupled to either or both of these two devices 100, 160. In this embodiment of the laser rangefinder module 80, it may be aimed at a target independently of the smartphone 100 or tablet computer 160. The laser rangefinder module 80, in this embodiment, comprises, for example, a laser fire button, 82 and an operational mode switch 84.

While there have been described above the principles of the present invention in conjunction with specific apparatus and structure, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

As used herein, the terms “comprises”, “comprising”, or any other variation thereof, are intended to cover a non-exclusive inclusion, such that a process, method, article, or apparatus that comprises a recitation of certain elements does not necessarily include only those elements but may include other elements not expressly recited or inherent to such process, method, article or apparatus. None of the description in the present application should be read as implying that any particular element, step, or function is an essential element which must be included in the claim scope and THE SCOPE OF THE PATENTED SUBJECT MATTER IS DEFINED ONLY BY THE CLAIMS AS ALLOWED. Moreover, none of the appended claims are intended to invoke paragraph six of 35 U.S.C. Sect. 112 unless the exact phrase “means for” is employed and is followed by a participle.

What is claimed is:

1. A laser rangefinder comprising:
a laser rangefinder module; and
a smartphone in operative association with said laser rangefinder, said smartphone comprising a user interface and an application program for operatively controlling said laser rangefinder module, said laser rangefinder module being at least partially operative in response to said smartphone user interface.

2. The laser rangefinder of claim 1 wherein said laser rangefinder module is operatively coupled to said smartphone by at least one electrical connector.

3. The laser rangefinder of claim 1 wherein said laser rangefinder module is operatively coupled to said smartphone by a wireless transceiver.

4. The laser rangefinder of claim 3 wherein said wireless transceiver is a Bluetooth transceiver.

5. The laser rangefinder of claim 3 wherein said wireless transceiver is a WLAN transceiver.

6. The laser rangefinder of claim 1 wherein said laser rangefinder module further comprises:
a viewing aperture optically coupled to a camera in said smartphone.

7. The laser rangefinder of claim 6 wherein said viewing aperture comprises a light redirecting element.

8. The laser rangefinder of claim 7 wherein said light redirecting element comprises a mirror.

9. The laser rangefinder of claim 6 wherein said laser smartphone further comprises:
a display for providing an image of a target through said viewing aperture.

10. The laser rangefinder of claim 9 wherein said display further provides information regarding a range to said target as determined by said laser rangefinder module.

11. The laser rangefinder of claim 1 wherein said smartphone further comprises:
an accelerometer for providing orientation information operative in conjunction with distance information determined by said laser rangefinder module.

12. The laser rangefinder of claim 1 wherein said smartphone further comprises:
a gyroscope for providing positional information operative in conjunction with distance information determined by said laser rangefinder module.

13. The laser rangefinder of claim 1 wherein said smartphone further comprises:
a global positioning system for providing geographic positional information operative in conjunction with distance information determined by said laser rangefinder module.

14. The laser rangefinder of claim 1 wherein said smartphone is physically coupled to said laser rangefinder module.

15. The laser rangefinder of claim 14 wherein said smartphone is removably coupled to said laser rangefinder module.

16. The laser rangefinder of claim 15 wherein said smartphone is removably coupled to said laser rangefinder module in a recess thereof.

17. A laser rangefinder module comprising:
a laser transmit section for directing laser energy toward a target;
a laser receive section for receiving at least a portion of said laser energy reflected from said target;
a central processing section for determining a distance to said target; and
a smartphone including a user viewable display, said smartphone in operative association with said central processing section to present information corresponding to said distance to said target on said display.

18. The laser rangefinder of claim 17 wherein said smartphone is wirelessly coupled to said laser rangefinder module.

19. The laser rangefinder of claim 18 wherein said laser rangefinder module is operatively coupled to said smartphone by a wireless transceiver.

20. The laser rangefinder of claim 19 wherein said wireless transceiver is a Bluetooth transceiver.

21. The laser rangefinder of claim 19 wherein said wireless transceiver is a WLAN transceiver.

22. The laser rangefinder of claim 17 wherein said smartphone is electrically coupled to said laser rangefinder module by a connector.

23. The laser rangefinder of claim 22 wherein said connector comprises a USB port.

24. The laser rangefinder of claim 22 wherein said connector comprises an RS232 port.

25. The laser rangefinder of claim 17 wherein said central processing section determines said distance to said target based on a phase relationship between said laser energy directed toward said target and said laser energy reflected from said target.

26. The laser rangefinder of claim 17 wherein said central processing section determines said distance to said target based on a flight time of said laser energy directed toward said target and said laser energy reflected from said target.

27. The laser rangefinder of claim 17 wherein said laser rangefinder module further comprises:
a viewing aperture optically coupled to a camera in said smartphone.

28. The laser rangefinder of claim 27 wherein said viewing aperture comprises a light redirecting element.

29. The laser rangefinder of claim 28 wherein said light redirecting element comprises a mirror.

30. The laser rangefinder of claim 17 wherein said display presents an image of said target.

31. The laser rangefinder of claim 20 wherein said display presents an aiming reticule superimposed upon said image of said target.

32. The laser rangefinder of claim 17 wherein said display comprises a touchscreen display.

33. The laser rangefinder of claim 17 wherein said smartphone further comprises:
an accelerometer for providing orientation information operative in conjunction with said distance determined by said laser rangefinder module.

34. The laser rangefinder of claim 17 wherein said smartphone further comprises:
a gyroscope for providing positional information operative in conjunction with said distance determined by said laser rangefinder module.

35. The laser rangefinder of claim 17 wherein said smartphone further comprises:
a global positioning system for providing geographic positional information operative in conjunction with said distance determined by said laser rangefinder module.

36. The laser rangefinder of claim 17 wherein said smartphone is physically coupled to said laser rangefinder module.

37. The laser rangefinder of claim 36 wherein said smartphone is removably coupled to said laser rangefinder module.

38. The laser rangefinder of claim 37 wherein said smartphone is removably coupled to said laser rangefinder module in a recess thereof.
